(19) United States
(12) Patent Application Publication
(10) Pub. No.: US 2002/0129243 A1
(43) Pub. Date: Sep. 12, 2002

(54) System for selective encryption of data packets

(76) Inventor: Viswanath Nanjundiah, Fremont, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/803,082

(22) Filed: Mar. 8, 2001

(51) Int. Cl. H04L 9/00

(52) U.S. Cl. 713/160

(57) ABSTRACT

A system and method of selectively encrypting data packets in a data packet sequence is disclosed. One or more data packets from a data packet sequence are selected for encryption to provide a plurality of selected packets and a plurality of unselected data packets. The selected data packets are then encrypted for transmission with the unselected data packets in a transmission medium.

### BACKGROUND

1. Field

The subject matter disclosed herein relates to data communication systems. In particular, the disclosed subject matter relates to data transmission using data packets.

2. Information

As public data communication networks such as the Internet have evolved, the need for secure data transmission has increased as parties have increasingly relied on such public data communication networks as a communication medium. Methods for ensuring secure data communication have typically been employed in applications such as the transmission of commercially sensitive information or the transmission of data as part of a subscription service.

Data encryption has been employed as a technique for ensuring secure communication between nodes in a data communication network. In a system for transmitting encrypted data, a data source typically encrypts original data according to an encryption code specified in an encryption key. The encrypted data may then be transmitted through a network to a data destination which has a copy of the encryption key to decrypt the received encrypted data, and recover the original data. Other parties with access to the network may receive the encrypted data but typically may not be able to recover the original data without the encryption key.

Data encryption at a data source and decryption of data at a data destination typically requires the use of processing resources such as CPU processing resources and memory. This is particularly the case when the underlying data to be transmitted securely is in the form of large files as in the transmission of streaming audio or video data. Accordingly, there is a need for techniques for the secure transmission of data from a source to a destination in a manner which uses processing resources efficiently.

### BRIEF DESCRIPTION OF THE FIGURES

Non-limiting and non-exhaustive embodiments of the present invention will be described with reference to the following figures, wherein like reference numerals refer to like parts throughout the various figures unless otherwise specified.

FIG. 1 shows a schematic diagram of a system for transmitting a data packet sequence according to an embodiment of the present invention.

FIG. 2 shows a flow diagram illustrating a process of selecting data packets in a data packet sequence for encryption.

### DETAILED DESCRIPTION

Reference throughout this specification to “one embodiment” or “an embodiment” means that a particular feature, structure, or characteristic described in connection with the embodiment is included in at least one embodiment of the present invention. Thus, the appearances of the phrase “in one embodiment” or “an embodiment” in various places throughout this specification are not necessarily all referring to the same embodiment. Furthermore, the particular features, structures, or characteristics may be combined in one or more embodiments.

“Machine-readable” instructions as referred to herein relates to expressions which may be understood by one or more machines for performing one or more logical operations. For example, machine-readable instructions may comprise instructions which are interpretable by a processor compiler for executing one or more operations one or more data objects. However, this is merely an example of machine-readable instructions and embodiments of the present invention are not limited in this respect.

“Machine-readable medium” as referred to herein relates to media capable of maintaining expressions which are perceivable by one or more machines. For example, a machine readable medium may comprise one or more storage devices for storing machine-readable instructions. However, this is merely an example of a machine-readable medium and embodiments of the present invention are not limited in this respect.

“Logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Also, logic may comprise processing circuitry in combination with machine-executable instructions stored in a memory. However, these are merely examples of structures which may provide logic and embodiments of the present invention are not limited in this respect.

A “data packet” as referred to herein relates to a quantity of data to be transmitted from a data source to a destination in a data network. A data packet may comprise a payload portion which contains a portion of a message or file to be transmitted to the destination. Such a message or file may be transmitted to the destination in the payload portions of more than one data packet for reassembly at the destination. A data packet may also comprise a header portion comprising destination data identifying an address of the destination in a data network. However, these are merely examples of a data packet and embodiments of the present invention are not limited in this respect.

A “data packet sequence” as referred to herein relates to a plurality of data packets in which at least some of the data packets have a payload portion to transmit a portion of a data item. Such data packets in a data packet sequence may comprise information indicating an ordinal position of the data packets within the data packet sequence. However, this is merely an example of a data packet sequence and embodiments of the present invention are not limited in this respect.

“Encryption” as referred to herein relates to a translation of data according to a secret code to provide encrypted data. For example, data may be encrypted according to an encryption process such that an encryption key may be used to recover the original data prior to the encryption process. However, this is merely an example of encryption and embodiments of the present invention are not limited in this respect.

A “transmission medium” as referred to herein relates to any media suitable for transmitting data. A transmission medium may include any one of several mediums including, for example transmission cabling, optical transmission medium or wireless transmission media. However, these are merely examples of transmission media and embodiments of the present invention are not limited in this respect.

“Video data” as referred to herein relates to data which comprises encoded data representing video frames. Such video data may be encoded into data packets in a data packet sequence for transmission to a destination. However, this is merely an example of video data and embodiments of the present invention are not limited in this respect.

“Data compression” as referred to herein relates to a process of encoding a first data item having a quantity of bits into a second data item having a smaller quantity of data. “Compressed video data” as referred to herein relates to video data which has been compressed. Such compressed video data may be compressed according to any of several compression formats including, for example, compression formats promulgated by the Moving Picture Experts Group (MPEG) and as provided in International Telecommunication Union (ITU) Recommendation ITU-T H.262 (1995). However, these are merely examples of compressed video data and embodiments of the present invention are not limited in these respects.

“Reference data packets” as referred to herein relates to one or more data packets in a data packet sequence having information which enables decoding or interpretation of other packets in the data packet sequence. For example, a data packet for an I-picture in a transmission of MPEG data may provide a reference data packet for the decoding or interpretation of data packets for associated B-pictures or P-pictures. Additionally, one or more reference data packets, by themselves or in combination with other data packets may enable the decoding or interpretation of other data packets in the data packet sequence. However, these are merely an examples reference data packets and embodiments of the present invention are not limited in this respect.

“Data packet sequence information” as referred to herein relates to information in one or more data packets of a data packet sequence which indicate a relationship of a data packet to one or more other data packets in the data packet sequence. Such data packet sequence information in a data packet may indicate that the data packet is a reference data packet. For example, data packet sequence information in a data packet may comprise a Sequence Header Code indicating that the packet comprises information for a beginning of an I-picture for a data packet sequence transmitting MPEG data. However, these are merely examples of data packet sequence information and embodiments of the present invention are not limited in these respects.

A “server” as referred to herein relates to a process which provides resources to nodes on network. Such a server may be hosted on a processing system and provide data services according to a communication protocol. However, this is merely an example of a server and embodiments of the present invention are not limited in this respect. A “client” as referred to herein is a process residing at a node in a network which utilizes resources provided by a server. Such a client may be hosted on a processing system at a node in a network and receive data services according to a communication protocol. However, this is merely an example of a client and embodiments of the present invention are limited in this respect.

Briefly, an embodiment of the present invention is directed to a system and method of selectively encrypting data packets in a data packet sequence. One or more data packets from a data packet sequence may be selected for encryption to provide a plurality of selected packets and a plurality of unselected data packets. The selected data packets are then encrypted for transmission with the unselected data packets in a transmission medium. However, this is merely one example of an embodiment of the present invention are other embodiments may not be limited in these respects.

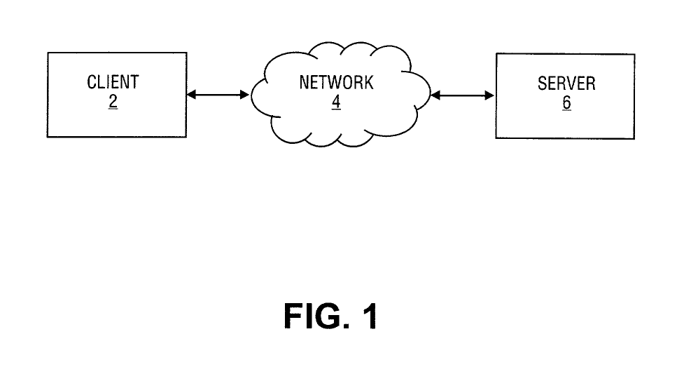

FIG. 1 shows a schematic diagram of a system for transmitting a data packet sequence according to an embodiment of the present invention. A client process 2 communicates with a server process 6 through a network 4. The network 4 may be any one of several public or private data communication networks including the Internet, local area networks or wide area networks. However, these are merely examples of a network which is capable of transmitting data between a client process and a server process, and embodiments of the present invention are not limited in this respect. Also, the network 4 may transmit data among nodes according to any one of several communication protocols including, for example, TCP/IP protocols. However, these are merely examples of communication protocols which may be used in transmitting data and embodiments of the present invention are not limited in this respect. Also, the network 4 may transmit data through any one of several transmission mediums including, for example, fiber optic cabling, coaxial cabling, twisted pair copper lines or wireless transmission media. However, these are merely examples of transmission media which may be used for transmitting data in a network and embodiments of the present invention are not limited in this respect.

The client process 2 and server process 6 may each be hosted on a processing system comprising processing resources such as one or more processors and memory. Such a processing system hosting the server process 6 may comprise processing resources for encoding or compressing data accord to a compression or encoding format, selecting portions of data to be encrypted, encrypting data and initiating the transmission of data to the network 4. A processing system hosting the client process 2 may comprise processing resources for receiving data from the network 4, decrypting data portions of the received data, and decoding or decompressing portions of the received data. However, these are merely examples of processing systems which may host a client process or a server process, and embodiments of the present invention are not limited in this respect.

According to an embodiment in which the client process 2 and server process 6 communicate through the network 4 according to a TCP/IP protocol, data may be transmitted from the server process 6 to the client process 2 in a Secure Sockets Layer (SSL) in which data packets from a data packet sequence are selectively encrypted and then combined with unencrypted data packets before transmission from the server process 6 to the client process 2. Such a SSL may be provided as defined in SSL Layer Protocol Ver. 3.0, Internet Engineering Task Force (IETF), Transport Layer Security Working Group, Nov. 18, 1996. However, this is merely an example of how a server process may securely transmit data to a client process and embodiments of the present invention are not limited in this respect.

According to an embodiment, the server process 6 may transmit a stream of data in an MPEG video stream to the client process 2 in the form of MPEG system layer packets from which image data may be decompressed/decoded and displayed. Data packets may transmit MPEG data to represent I-pictures, B-pictures or P-pictures as described in ITU recommendation ITU-T H.262 (1995). As known to those of ordinary skill in the art, information representing an I-picture may be used to decode/decompress MPEG data representing associated B-pictures or P-pictures. Accordingly, encrypting all or a portion of an I-picture may prevent decompression/decoding of unencrypted B-pictures or P-pictures without decryption of the encrypted portions of the I-picture data.

According to an embodiment, the server process 6 may selectively encrypt data packets in an MPEG data packet sequence for transmission in a SSL. For example, the server process 6 may examine each packet in the MPEG data packet sequence to identify reference data packet such as a data packet indicating the beginning of an I-picture. Such a packet may comprise data packet sequence information such as a Sequence Header Code. This packet and other packets may then be encrypted before transmission in the SSL. According to an embodiment, the server process 6 encrypts each packet having the sequence header code (indicating the beginning of an I-picture) and every Nth packet (where N is a positive integer) thereafter until the beginning of a subsequent I-picture is detected. However, this is merely an example of how a server may selectively encrypt data packets for transmission in a SSL and embodiments of the present invention are not limited in this respect.

According to an embodiment, a data packet transmitted in an SSL may comprise a header indicating whether the payload portion of the data packet does not have encrypted data. Such data in the header may include a CipherSpec symbol “SSL_NULL_WITH_NULL” to indicate that no decryption is required at a receiving client process. For other packets, the receiving client process may use a shared key for decrypting. Such a shared key may be established between a server process and the receiving client process using a “key exchange” as provided by systems developed by RSA Data Security, Inc. However, these are merely examples of how a client process may decrypt received data packets and embodiments of the present invention are not limited in these respects.

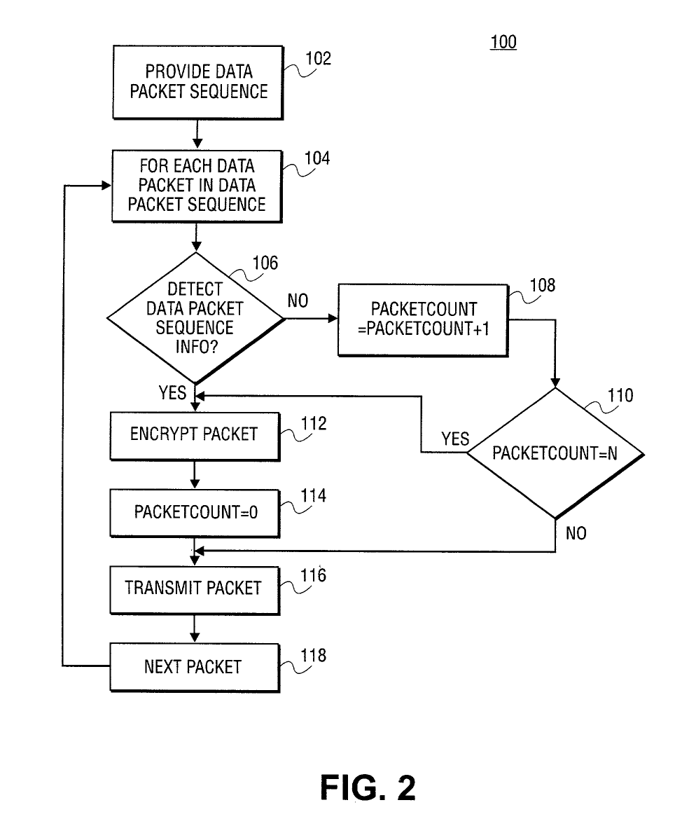

FIG. 2 shows a flow diagram illustrating a process 100 of selecting data packets in a data packet sequence for encryption. The process 100 may be executed by a processing system hosting a server process. However, this is merely an example of how the process 100 may be executed and embodiments of the present invention are not limited in this respect. At block 102, a data packet sequence (such as a data packet sequence transmitting MPEG data) is provided to a server process. A loop defined between blocks 104 and 118 provides a process for selecting data packets from the data packet sequence for encryption. Certain data packets in the data packet sequence are “selected” for encryption at diamond 106 or diamond 110 while other packets in the data packet sequence remain “unselected.” The selected and unselected data packets are transmitted as an output data packet sequence at block 116.

For each data packet, diamond 106 determines whether certain data packet sequence information (such as a Sequence Header Code indicating a beginning of an I-picture) is present. If the data packet sequence information is present, the data packet is selected for encryption at block 112 before transmission at block 116 and a counter “PacketCount” is initialized to zero at block 114. Block 112 may employ any one of several techniques for encrypting data packets according to an encryption key including, for example, standard encryption techniques including RC4, DES, DES3 and the like. However, these are merely examples of encryption techniques which may be used and embodiments of the present invention are not limited in this respect.

Block 108 and diamond 110 enable the selection of every Nth packet in a data packet sequence for encryption following a data packet with certain data packet sequence information (such as a sequence header code indicating a beginning of an I-picture). If diamond 106 does not detect a presence of the data packet sequence information in a data packet, block 108 increments PacketCount and diamond 110 determines whether the data packet is the “Nth” data packet since the last encrypted data packet. If the data packet is the Nth data packet since the last encrypted data packet, block 112 may encrypt the data packet.

The process 100 illustrated with reference to FIG. 2 may securely transmit an output data packet sequence to a data destination such as the client process 2 (FIG. 1) by only encrypting selected data packets in an original data packet sequence. Based upon the available processing resources for encryption at the data source and for decryption at a data destination, the parameter “N” may be varied to provide a greater level of security (i.e., smaller integer N) using more processing resources or a lesser level of security (i.e., larger integer N) using less processing resources.

Upon receipt of the output data packet sequence, such a data destination may then execute a process to extract desired data from the received data packet sequence. Such a process may be executed by a processing system hosting a client process, for example. The data destination may decrypt the selectively encrypted packets in the received data packet sequence according to an encryption key established between the data source and the data destination. As discussed above, the data destination may selectively decrypt received data packets as those packets that do not have a “SSL_NULL_WITH_NULL” CipherSpec symbol in the respective headers. Alternatively, the data destination may examine a sequence number in the SSL data packet to isolate every “Nth” data packet for decrypting while not decrypting data packets between consecutive Nth data packets. However, these are merely examples of how a data destination may determine which received data packets to decrypt and embodiments of the present invention are not limited in these respects.

Upon decrypting the selected packets (e.g., data packets indicating the beginning of an I-picture in an embodiment for transmitting MPEG data), the data destination may generate the data packet sequence provided at block 102. The data destination may then perform additional processing such as decoding, depacketizing or decompression to recover the desired signals. Accordingly, the desired signal may be recovered by decrypting only the selected data packets.

While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein. Therefore, it is intended that the present invention not be limited to the particular embodiments disclosed, but that the invention include all embodiments falling within the scope of the appended claims.

What is claimed is:

1. A method comprising:
selecting one or more data packets from a data packet sequence for encryption to provide a plurality of selected packets and a plurality of unselected data packets;
encrypting the selected data packets; and
initiating the transmission of the encrypted data packets and unselected data packets as an output data packet sequence in a transmission medium.

2. The method of claim 1, wherein method further comprises:
detecting data packet sequence information in one or more reference data packets in the data packet sequence; and
selecting the reference data packets for encryption.

3. The method of claim 2, wherein the data packet sequence comprises an ordered sequence of data packets and method further comprises selecting every Nth data packet in the data packet sequence for encryption over at least a portion of the data packet sequence.

4. The method of claim 1, wherein the data packet sequence comprises compressed video data.

5. The method of claim 4, wherein the compressed video data comprises MPEG video data, and the method further comprises selecting at least data packets of I-pictures having a sequence header code for encryption.

6. The method of claim 5, wherein the method further comprises
selecting every Nth data packet in the data packet sequence between consecutive data packets having a sequence header code.

7. An apparatus comprising:
means for selecting one or more data packets from a data packet sequence for encryption to provide a plurality of selected data packets and a plurality of unselected data packets;
means for encrypting the selected data packets; and
means for initiating the transmission of the encrypted data packets and unselected data packets as an output data packet sequence in a transmission medium.

8. The apparatus of claim 7, wherein apparatus further comprises:
means for detecting data packet sequence information in one or more reference data packets in the data packet sequence; and
means for selecting the reference data packets for encryption.

9. The apparatus of claim 8, wherein the data packet sequence comprises an ordered sequence of data packets and apparatus further comprises means for selecting every Nth data packet in the data packet sequence for encryption over at least a portion of the data packet sequence.

10. The apparatus of claim 7, wherein the data packet sequence comprises compressed video data.

11. The apparatus of claim 10, wherein the compressed video data comprises MPEG video data, and the apparatus further comprises means for selecting at least data packets of I-pictures having a sequence header code for encryption.

12. The apparatus of claim 11, wherein the apparatus further comprises means for selecting every Nth data packet in the data packet sequence between consecutive data packets having a sequence header code.

13. A system of transmitting a data stream in a transmission medium, the system comprising:
a data transmission source comprising:
logic to select one or more data packets from a data packet sequence for encryption to provide a plurality of selected packets and a plurality of unselected data packets;
logic to encrypt the selected data packets; and
logic to initiate the transmission of the encrypted data packets with the unselected data packets as an output data packet sequence in the transmission medium; and
a data destination adapted to receive the transmitted output data packet sequence.

14. The system of claim 13, wherein the data source further comprises:
logic to detect data packet sequence information in one or more reference data packets in the data packet sequence; and
logic to select the reference data packets for encryption.

15. The system of claim 14, wherein the data packet sequence comprises an ordered sequence of data packets and data source further comprises logic to select every Nth data packet in the data packet sequence for encryption over at least a portion of the data packet sequence.

16. The system of claim 13, wherein the data packet sequence comprises compressed video data.

17. The system of claim 16, wherein the compressed video data comprises MPEG video data, and the data source further comprises logic to select at least data packets of I-pictures having a sequence header code for encryption.

18. The system of claim 17, wherein the data source further comprises logic to select every Nth data packet in the data packet sequence between consecutive data packets having a sequence header code.

19. An article comprising:
a storage medium comprising machine-readable instructions stored thereon for:
selecting one or more data packets from a data packet sequence for encryption to provide a plurality of selected packets and a plurality of unselected data packets;
encrypting the selected data packets; and
initiating the transmission of the encrypted data packets with the unselected data packets as an output data packet sequence in a transmission medium.

20. The article of claim 19, wherein the storage medium further comprises machine-readable instructions stored thereon for:
detecting data packet sequence information in one or more reference data packets in the data packet sequence; and
selecting the reference data packets for encryption.

21. The article of claim 20, wherein the data packet sequence comprises an ordered sequence of data packets and storage medium further comprises machine-readable instructions stored thereon for selecting every Nth data packet in the data packet sequence for encryption over at least a portion of the data packet sequence.

22. The article of claim 19, wherein the data packet sequence comprises compressed video data.

23. The article of claim 22, wherein the compressed video data comprises MPEG video data, and the storage medium method further comprises machine-readable instructions stored thereon for selecting at least data packets of I-pictures having a sequence header code for encryption.

24. The article of claim 23, wherein the storage medium further comprises machine-readable instructions stored thereon for selecting every Nth data packet in the data packet sequence between consecutive data packets having a sequence header code.

25. A method comprising:
receiving a data packet sequence comprising encrypted data packets and unencrypted data packets;
decrypting one or more of the encrypted data packets to provide decrypted information; and
decoding or decompressing information in one or more unencrypted data packets based upon the decrypted information.

26. The method of claim 25, wherein the data packet sequence comprises MPEG video data and the method further comprises:
decrypting one or more of the encrypted data packets to provide I-picture data; and
decoding or decompressing information in one or more of the unencrypted data packets to provide one of B-picture data and P-picture data based upon the I-picture data.

27. An apparatus comprising:
means for receiving a data packet sequence comprising encrypted data packets and unencrypted data packets;
means for decrypting one or more of the encrypted data packets to provide decrypted information; and
means for decoding or decompressing information in one or more unencrypted data packets based upon the decrypted information.

28. The apparatus of claim 27, wherein the data packet sequence comprises MPEG video data and the method further comprises:
means for decrypting one or more of the encrypted data packets to provide I-picture data; and
means for decoding or decompressing information in one or more of the unencrypted data packets to provide one of B-picture data and P-picture data based upon the I-picture data.

29. An article comprising:
a storage medium comprising machine-readable instructions stored thereon for:
receiving a data packet sequence comprising encrypted data packets and unencrypted data packets;
decrypting one or more of the encrypted data packets to provide decrypted information; and
decoding or decompressing information in one or more unencrypted data packets based upon the decrypted information.

30. The article of claim 29, wherein the data packet sequence comprises MPEG video data and the storage medium further comprises machine-readable instructions stored thereon for:
decrypting one or more of the encrypted data packets to provide I-picture data; and
decoding or decompressing information in one or more of the unencrypted data packets to provide one of B-picture data and P-picture data based upon the I-picture data.
